(19) United States
(12) Patent Application Publication
(10) Pub. No.: US 2025/0383205 A1
(43) Pub. Date: Dec. 18, 2025

(54) SENSOR UNIT AND METHOD FOR OPERATING A SENSOR UNIT

(71) Applicant: Robert Bosch GmbH, Stuttgart (DE)

(72) Inventors: Patrick Tritschler, Engen (DE); Peter Degenfeld-Schonburg, Renningen (DE); Fabian Zschocke, Ludwigsburg (DE)

(21) Appl. No.: 19/237,710

(22) Filed: Jun. 13, 2025

(30) Foreign Application Priority Data
Jun. 17, 2024 (DE) 10 2024 205 569.7

(51) Int. Cl. G01C 19/72; G01C 19/00

(52) U.S. Cl. CPC G01C 19/721; G01C 19/005; G01C 19/727

(57) ABSTRACT

A sensor unit having a coupling-in waveguide and a coupling-in unit which couples a state present on the coupling-in waveguide to a first waveguide and a second waveguide. The sensor unit includes a first coupling-out unit that couples in a state present on the first waveguide to a coupling waveguide and couples out a state present on the coupling waveguide to a first coupling-out waveguide. The sensor unit includes a second coupling-out unit which couples in a state present on the second waveguide to the coupling waveguide and couples out a state present on the coupling waveguide to a second coupling-out which couples with the coupling waveguide, and a detection unit including at least one detector for detecting states present at or output from the at least first and/or second coupling-out waveguide or states dependent on these states.

### CROSS REFERENCE

The present application claims the benefit under 35 U.S.C. § 119 of Germany Patent Application No. DE 10 2024 205 569.7 filed on Jun. 17, 2024, which is expressly incorporated herein by reference in its entirety.

### FIELD

The present invention relates to a sensor unit and a method for operating a sensor unit. The present invention also relates to a computer program.

### BACKGROUND INFORMATION

Current optical gyroscopes are either very large in order to ensure good sensitivity, or are not sensitive enough for chip-integrated applications. Such embodiments of gyroscopes make the wide availability of universal applicability difficult, so that very precise measurements are only available at high cost and for certain special applications. In this context, chip-integrated quantum measurements may for example require, in addition to a pump laser, additional signal lasers which correspond to the frequency of the generated quantum state in order to perform a homodyne or heterodyne measurement. This significantly increases the measurement effort and thus also the costs of the overall systems, since a plurality of laser sources are required. Furthermore, the systems become more error-prone because all lasers used must be stabilized and controlled. This can require a large outlay of control effort, especially when generating quantum states via four-wave mixing, since a total of three lasers have to be used.

### SUMMARY

The approach presented here according to the present invention provides, among other things, a sensor unit, a method for operating a sensor unit, a control device that uses this method, and, a corresponding computer program. Advantageous developments and improvements of the device of the present invention are made possible by the measures disclosed herein.

The present invention provides a sensor unit. According to an example embodiment of the present invention, the sensor unit includes the following features:
a coupling-in waveguide;
a coupling-in unit designed to couple a state present on the coupling-in waveguide to a first waveguide and a second waveguide;
a first coupling-out unit designed to couple a state present on the first waveguide into a coupling waveguide and to couple a state present on the coupling waveguide out to a first coupling-out waveguide;
a second coupling-out unit designed to couple a state present on the second waveguide into the coupling waveguide and to couple a state present on the coupling waveguide out to a second coupling-out waveguide;
a ring resonator designed to couple with the coupling waveguide; and
a detection unit which comprises at least one detector for detecting states present at or output from the at least first and/or second coupling-out waveguide or states dependent on these states.

For example, this sensor unit can be compact, specially constructed on a substrate or integrated into a chip. In the present case, a coupling-in unit and/or a coupling-out unit can be understood as, for example, a multimode interferometer or an arrangement of waveguides arranged closely alongside one another (for example, within a range of one millimeter). As a result, using the Hong-Ou-Mandel effect., an entanglement of states such as photons in or at the two coupled time periods can be achieved. A state can thus also be understood as light or, in general, photons that are guided in one of the waveguides.

The approach presented here according to the present invention is based on the finding that the sensor unit can perform a very precise and robust measurement if the ring resonator can be fed with light from two different directions through the coupling waveguide. As a result, it is possible to optimize the measurement accuracy and robustness of the sensor unit, especially when detecting a rate of rotation or rotations in general, by specifying a desired pumping direction with which the ring resonator is pumped.

The approach presented here according the present invention makes possible the realization of an optical chip-integrated gyroscope that can measure a rate of rotation and has a high sensitivity. An advantage of the approach presented here is that it is possible in a compact sensor system that can be built in chip-integrated fashion. For this purpose, the Hong-Ou-Mandel effect is used for entanglement or the intrinsic time-frequency entanglement or squeezing. A quantum state can be created using a ring resonator. By exploiting certain quantum states and measurement methods, a robust sensor over a wide temperature range is possible.

Particularly advantageous is an example embodiment of the present invention in which the coupling-in unit is designed to asymmetrically couple the state present on the coupling-in waveguide to a first waveguide and a second waveguide. Such an embodiment offers the advantage of being able to make a particularly precise measurement if a larger part of the intensity of a state or a quantity of photons can be coupled in a desired pumping direction in order to pump the ring resonator in a corresponding manner.

Moreover, according to another example embodiment of the present invention, the coupling-in unit can comprise at least a first and a second subunit, wherein the first subunit is designed to couple a state present at the coupling-in waveguide to at least two coupling-in sub-waveguides, wherein the second subunit is coupled with the two coupling-in sub-waveguides. By splitting the coupling-in unit into two subunits coupled with one another, there is now the advantage of being able to vary part of the state or light output by the first subunit, for example in the form of a shift of a phase. In this way, the precision of a measurement performed by the sensor unit can be further improved, since the ring resonator can be pumped in a very flexible and finely tuned manner.

According to a further example embodiment of the present invention, a Mach-Zehnder interferometer can be arranged between the first and the second coupling-out waveguide and the at least one detector, in particular wherein an interferometer coupling-in unit is provided which is designed to couple a state of the first and second coupling-out waveguide into the Mach-Zehnder interferometer. Such an embodiment offers the advantage that the connection of the ring resonator in front of the Mach-Zehnder interferometer makes possible a significant improvement in the precision of the detection of measured values.

According to a further example embodiment of the present invention, the second coupling-out waveguide can also be coupled with the at least one detector in a manner bypassing the Mach-Zehnder interferometer. Such an embodiment advantageously makes a determination of physical effects on the Mach-Zehnder interferometer possible, which can then be verified by evaluating results from the detector.

Furthermore, an example embodiment of the present invention is possible wherein the detection unit comprises at least one further detector for detecting states present at or output from the at least first and/or second coupling-out waveguide or states dependent on these states. Such an embodiment advantageously makes possible the evaluation of different parameters that can be provided by the Mach-Zehnder interferometer or the first and/or second coupling-out waveguide in the different detectors. For example, the values provided by the different detectors can be linked together and a particularly precise ascertaining of a physical quantity can be realized from this as a measured value.

A particularly favorable example embodiment of the present invention is one in which the detection unit is designed to provide a sensor signal using a detection signal of the first detector and a further detection signal of the at least one further detector, in particular wherein the sensor signal represents a rate of rotation and/or rotation of the sensor unit. Such an embodiment makes possible a very accurate or precise determination of the physical quantity using means that are technically relatively simple.

Another advantageous embodiment of the present invention is one in which in addition at least one light source and/or a laser light source is provided which is designed to transmit a light into the coupling-in waveguide. Such an embodiment offers the advantage of, on the one hand, a compact sensor unit, and, on the other hand, the determination of very precise measurement results by using the favorable properties of the light emitted by the light source.

According to a further embodiment of the present invention, the ring resonator can be designed to generate a quantum state using four-wave mixing and/or the Kerr effect. A ring resonator designed in this way, on the one hand, is technically very simple to realize and, on the other hand, provides quantum states that can be advantageously used in the downstream Mach-Zehnder interferometer or in an evaluation in the detector.

In order specifically to be able to also, for example, couple light from outside a substrate into a sensor unit and/or to be able to couple light from inside a substrate out of the sensor unit, which is constructed in one piece in its own substrate, according to a particularly favorable embodiment of the approach proposed here, at least one grating coupler or lateral coupling and/or with taper structures for coupling light into the coupling waveguide or for outputting light to at least the detector of the detection unit can be provided.

An embodiment of the present invention is particularly favorable in which at least one phase shifter element is provided for varying a state guided on the first and/or second waveguide, the coupling-in sub-waveguide and/or the Mach-Zehnder interferometer. Such an embodiment offers the advantage that, due to the possibility of a phase variation of a quantum state on conduction unit in the sensor unit, the latter can be operated at particularly favorable operating points, specifically at those where the sensor unit can detect a certain physical quantity such as a rate of rotation or a rotation with very high sensitivity or precision. An embodiment of the approach presented here is also conceivable in which the sensor unit comprises a temperature sensor for ascertaining a temperature for controlling an operation of the sensor unit. As a result, a very robust and efficient operation of the sensor unit can be realized.

An advantageous example embodiment of the present invention is a method for operating a sensor unit according to an embodiment presented here, wherein the method comprises the following steps:
illuminating at least the coupling-in waveguide having a light; and
evaluating a received light received by at least the detector to obtain a sensor signal.

This method can be implemented, for example, in software or hardware or in a mixed form of software and hardware, for example in a control device.

The present invention further provides a control unit which is designed to carry out, control or implement the steps of a variant of a method of the present invention in corresponding devices. The object of the present invention can also be achieved quickly and efficiently by this design variant of the invention in the form of a control unit.

For this purpose, according to an example embodiment of the present invention, the control unit can comprise at least one computing unit for processing signals or data, at least one memory unit for storing signals or data, at least one interface to a sensor or an actuator for reading sensor signals from the sensor or for outputting data signals or control signals to the actuator and/or at least one communication interface for reading or outputting data embedded in a communication protocol. The computing unit can, for example, be a signal processor, a microcontroller or the like, and the memory unit can be a flash memory or a magnetic memory unit. The communication interface can be designed to read or output data wirelessly and/or in a wired form, a communication interface, which can read or output wired data, being able to read these data, for example electrically or optically, from a corresponding data transmission line, or being able to output these data into a corresponding data transmission line.

In the present case, a control unit can be understood to be an electrical device that processes sensor signals and, on the basis of these signals, outputs control and/or data signals. The control unit can have an interface that can be designed as hardware and/or software. In a hardware embodiment, the interfaces can, for example, be part of a so-called system ASIC, which contains a wide variety of functions of the device. However, it is also possible for the interfaces to be separate integrated circuits or at least partially consist of discrete components. In the case of a software embodiment being used, the interfaces can be software modules that are present, for example, on a microcontroller in addition to other software modules.

A computer program product or a computer program having program code that can be stored on a machine-readable carrier or storage medium, such as a semiconductor memory, a hard disk memory, or an optical memory, and that is used for carrying out, implementing, and/or controlling the steps of the method according to one of the embodiments of the present invention described above, in particular when the program product or program is executed on a computer or a device, is advantageous as well.

Exemplary embodiments of the present invention are illustrated in the figures and explained in more detail in the following description.

### BRIEF DESCRIPTION OF THE DRAWINGS

FIG. 1 shows a block diagram of a sensor unit according to an exemplary embodiment of the present invention.

FIG. 2 shows a block diagram of a sensor unit according to a further exemplary embodiment of the present invention.

FIG. 3 shows a block diagram of a further exemplary embodiment of the sensor unit according to the present invention.

FIG. 4 shows a block diagram of a further exemplary embodiment of the sensor unit according to the present invention.

FIG. 5 shows a schematic representation of the quantum states generated via four-wave mixing.

FIG. 6 shows a flow diagram of an exemplary embodiment of a method for operating a variant presented here of a sensor unit according to the present invention.

FIG. 7 shows a block diagram of an exemplary embodiment of a control unit for executing the steps of the method for operating the variant of the sensor unit according to the present invention.

### DETAILED DESCRIPTION OF EXAMPLE EMBODIMENTS

In the following description of advantageous exemplary embodiments of the present invention, the same or similar reference signs are used for the elements shown in the various figures and acting similarly, as a result of which a repeated description of these elements is omitted.

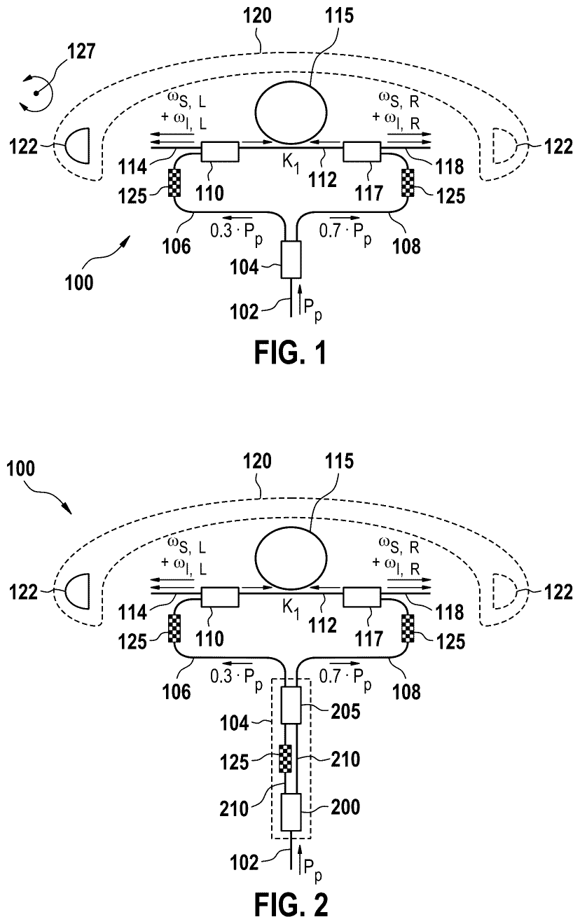

FIG. 1 shows a block diagram of a sensor unit 100 according to an exemplary embodiment. The sensor unit 100 comprises a coupling-in waveguide 102 for receiving or coupling in states or light, which can be output, for example, by a light or laser source not shown in FIG. 1. The one sensor unit 100 further comprises a coupling-in unit 104 which is designed to couple a state present on the coupling-in waveguide 102 to a first waveguide 106 and a second waveguide 108. For example, this coupling can (but does not have to) be done in such a way that an asymmetric coupling takes place. For example, the intensity of the light or photons on the first waveguide 106 may be thirty percent of the intensity of the light on the coupling-in waveguide 102, whereas the intensity of the light on the second waveguide 108 may be seventy percent of the intensity of the light on the coupling-in waveguide 102. Furthermore, the exemplary embodiment of the sensor unit 100 shown in FIG. 1 comprises a first coupling-out unit 110, which is designed to couple a state present on the first waveguide 106 to a coupling waveguide 112 and to couple a state present on the coupling waveguide 112 to a first coupling-out waveguide 143. A ring resonator 115 of the sensor unit 100 is also designed to couple with the coupling waveguide 112. At the same time, the sensor unit 100 comprises a second coupling-out unit 117, which is designed to couple a state present on the second waveguide 108 to the coupling waveguide 112 and to couple a state present on the coupling waveguide 112 to a second coupling-out waveguide 118. Finally, the sensor unit 100 comprises a detection unit 120, which comprises at least one detector 122 for detecting states present at or output from the at least first 112 and/or second 118 coupling-out waveguide or states dependent on these states. In this case, the detection unit 120 or the detector 122 does not need to be able to detect states output directly at the one first coupling-out waveguide 114 and/or the second coupling-out waveguide 118; rather, the states output at the first coupling-out waveguide 114 and/or the second coupling-out waveguide 118 can also be processed using further components, as described in more detail below. It is also conceivable that a phase shifting element 125 is arranged on, in and/or at (for example each of) the first waveguide 106 and/or the second waveguide 108 in order to make possible a variation of the state guided on the respective waveguide 106 or 108.

FIG. 1 thus shows a schematic structure of the asymmetrically pumped ring in a possible asymmetric multimode interferometer as a coupling-in unit 104 having a pitch of 0.3 to 0.7. In this case, ω_{S,Links}+ω_{I,Links}>>ω_{S,Rechts}+ω_{I,Rechts} holds, and the left output can be used as a signal laser, where ω_{S,L(eft)} represents a state of the photons as signal laser on the side of the left, i.e. first, coupling-out waveguide 104, ω_{I,L(left)} represents a state of the photons as modulated intensity on the side of the left, i.e. first, coupling-out waveguide 104, ω_{S,R(ight)} represents a state of the photons as signal laser on the side of the right, i.e. second, coupling-out waveguide 118, and ω_{I, R(ight)s} represents a state of the photons as modulated intensity on the side of the right, i.e. second, coupling-out waveguide 118. If a light or photons are now supplied as corresponding states to the coupling-in unit 104 via the coupling-in waveguide 102, a division of the intensity or power of the supplied states into the first waveguide 106 and the second waveguide 108 is carried out in this coupling-in unit 104, so that the distribution shown in FIG. 1 results. The corresponding states or intensities are then coupled into the coupling waveguide 112 via the first coupling-out unit 110 and the second coupling-out unit 117 in order to couple there with the ring resonator 115. Here, the ring resonator 115 forms the sensor region, so that the states guided in the ring resonator 115 are changed accordingly by the Sagnac effect, depending on a rotation of the sensor unit 100 about the axis of rotation 127, and this change can be detected and correspondingly evaluated at least by the detector through the states then coupled out from the ring resonator 115 back into the coupling waveguide 112 and via the first coupling-out unit 110 or the second coupling-out unit 118.

FIG. 2 shows a block diagram of a further exemplary embodiment of a sensor unit 100. In contrast to the exemplary embodiment of the sensor unit 100 shown in FIG. 1, the coupling-in unit 104 is now divided into a first subunit 200 and a second subunit 205. The first subunit is coupled with the coupling-in waveguide 102 for coupling the states and couples the received states to a first coupling-in waveguide 210 and a second coupling-in waveguide 215. Both the first coupling-in waveguide 210 and the second coupling-in waveguide 215 are coupled with the second subunit 205, wherein a phase shift element 125 also acts on the second coupling-in waveguide 215 to vary the phases of the states guided in the second coupling-in waveguide 215.

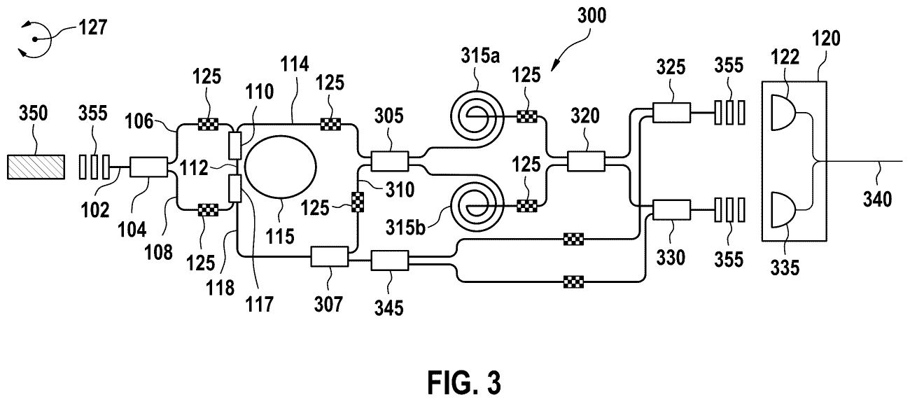

FIG. 3 shows a block diagram of a further exemplary embodiment of the sensor unit 100 presented here. In addition to the components of the sensor unit 100 shown in FIG. 1, this exemplary embodiment further comprises a Mach-Zehnder interferometer 300, which comprises an interferometer coupling-in unit 305 (for example, in the form of a coupling point or a multimode interferometer) for receiving quantum states or photons from the first coupling-out waveguide 114 and the second coupling-out waveguide 118 (via a coupling point 307 and a further waveguide 310), and comprises a sensor portion which is divided into a first sensor sub-portion 315a and a second sensor sub-portion 315b. The sensor sub-portions 315 can, for example, be waveguides having a predetermined (advantageously equal) length, but which are constructed or arranged in a spiral shape for reasons of space. The two sensor sub-portions 315 are coupled and/or entangled, via a coupling point acting as output 320 of the Mach-Zehnder interferometer 300, having an output coupling point 325 which is designed to output quantum states or photons to the detector 122 of the detector unit 120. Furthermore, a further output coupling point 330 is coupled and/or entangled with the output 320 of the Mach-Zehnder interferometer 300, which output coupling point is designed to output quantum states or photons to a further detector 335 of the detector unit 120. The detector unit 120 is designed for example to provide a sensor signal 340 using sensor values from the detector 122 and the further detector 335, which signal represents for example a rate of rotation and/or a rotation of the sensor unit 100 about an axis of rotation 127.

In addition, according to the exemplary embodiment shown in FIG. 3, for the sensor unit 100 an input coupling point 345 is provided which connects the second coupling-out waveguide to the output coupling point 325, and/or additionally or alternatively to the further output coupling point 330, in a manner that bypasses the Mach-Zehnder interferometer 300.

Furthermore, according to the exemplary embodiment shown in FIG. 1 a light source 350 is provided which is configured for example as a pump laser light source and which is designed to send light into coupling-in waveguide 102.

It is also conceivable that grating couplers 355 are used to couple light from the light source 350 into the coupling-in waveguide 102 if this sensor unit 100 is integrated on a common substrate or chip and the light source 350 is arranged outside this substrate or the chip. Analogously, corresponding grating couplers 355 can also be used to couple corresponding quantum states or photons from the output coupling point 325 to the detector 122 and/or from the further output coupling point 330 to the further detector 335, especially if one or more of the detectors of the detector unit 120 are not integrated on a common substrate with the other components of the sensor unit 100.

It is also conceivable to use phase shifters or phase shift elements 125 on and/or in individual conductor components of the components of the sensor unit 100, in particular wherein the phase shift elements 125 are configured such that they can be controlled individually or jointly in such a way that they can control certain phase shifts or delays of states occurring on the respective conductor components. For this purpose, for example a control unit not shown in FIG. 3 can be used, which can control the individual phase shift elements 125.

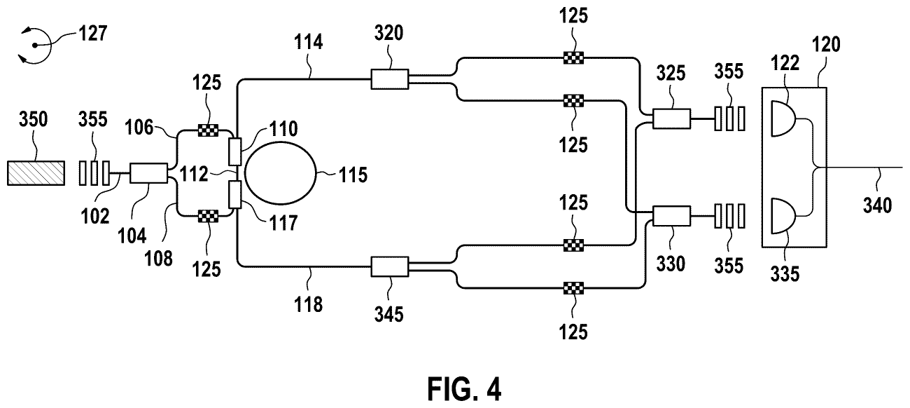

FIG. 4 shows a block diagram of a further exemplary embodiment of the sensor unit 100 presented here. In contrast to the exemplary embodiment shown in FIG. 3, the Mach-Zehnder interferometer 300 including the coupling point 307 is now omitted, so that the first coupling-out waveguide 114 can couple directly to the output 320 as a coupling point. In this exemplary embodiment, however, phase shifting elements 125 are provided in or on the waveguides between the output 320 and the output coupling point 325 and the output 320 and the further output coupling point 330.

The approach presented here thus proposes an architecture in which a quantum state is generated, for example, via four-wave mixing. These can be achieved in the ring resonator 115, which is pumped with a light source 350 or a pump laser, and squeezed signal light is generated. At the same time, for example, the ring resonator 115 is pumped in the opposite direction of rotation with a higher power and coherent light is generated, which represents the signal laser. This is achieved for example by dividing the coupled-in pump laser into unequal parts using a Mach-Zehnder structure or multimode interferometer.

In order to realize the ring laser gyroscopes, a homodyne measurement is subsequently realized on the ring to measure the quantum state.

With the approach presented here, during the four-wave mixing the signal lasers are generated directly on the chip and can be used for the homodyne or heterodyne measurement. This results in significantly smaller and simpler systems. In addition, the ring resonator in which the quantum states arise can be used directly as a sensor or sensor region. This makes it possible to use the four-wave mixing as quantum amplification and thus to realize sensitive and robust ring laser gyroscopes.

In order to perform such a measurement of a rate of rotation, light (e.g., from a laser source) is either generated directly on an optical chip or is coupled into it via lateral coupling or from above/below (e.g., using the grating couplers mentioned). In this further option, the laser or the light source in general can thus be positioned directly above the grating coupler and guided via a taper structure from the grating coupler into a waveguide, which is usually made of silicon (Si) or silicon nitride (SiN). The laser or light source here corresponds to a pump laser or a pump light source. The light or laser light is coupled into the ring resonator 115, for example, via lateral waveguide coupling or via multimode interferometers. As is usual for resonators, an increase in the field and thus a high intensity occurs in this resonator. At sufficiently high intensity, it is possible for Si and SiN to generate squeezed photon pairs, which represent the quantum state, via four-wave mixing. In the resulting quantum states, there is the effect that the squeezing as well as the intensity thereof changes with changing pump intensity. If a strong pump power is directed into the ring, so that σ≈1 approximately holds, the squeezing is at a maximum, which is good for the signal light. If σ>>1, then it can be seen that the squeezing decreases, but the intensity of the resulting light increases significantly.

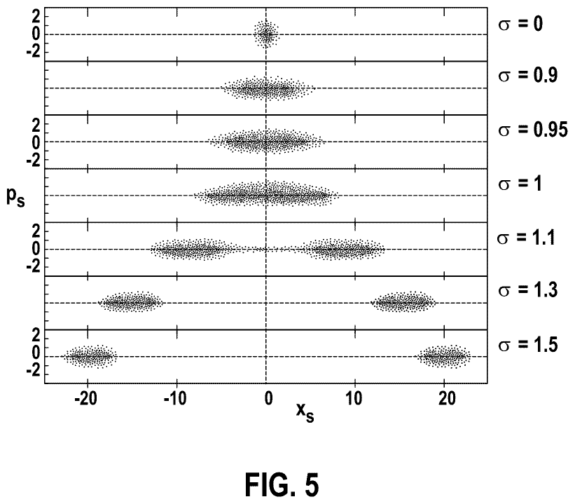

FIG. 5 shows a schematic representation of the generated quantum state via four-wave mixing. Here, o corresponds to a combination of the resonance condition and the pump light intensity. If this is higher, the four-wave mixing intensity is higher (recognizable by a higher x_s) and up to a value of σ=1, the squeezing becomes larger and then smaller again; this can be seen in FIG. 5 by a larger absolute value for xₛ. The resulting light can be used as a signal laser for a homodyne or heterodyne measurement.

In the structure proposed here by way of example, the pump light is split into two parts of different intensity using an asymmetric multimode interferometer as the coupling-in unit 104. The ring resonator 115 is then pumped from two different directions with different intensities. This allows two quantum states to be created. One has high squeezing and low intensity and one has low squeezing and high intensity. The first state can be used as a quantum state, while the second can be used as a signal laser to realize the homodyne measurement. This has the advantage that even in the event of temperature fluctuation or other external influencing factors, the wavelength of the signal laser and of the quantum states remains identical. This makes the measurement method robust against the situation of an additional signal laser. Such an arrangement is shown in FIG. 1, as already explained. The division 0.3 to 0.7 is only shown or chosen schematically. Any other division can also be realized.

In a further exemplary embodiment, the intensity distribution is realized by a Mach-Zehnder structure, as shown in FIG. 2. Here, one path of the Mach-Zehnder interferometer has a phase shifter 125 as a coupling-in unit. This phase shifter 125 can thus be used to control the intensity distribution in the second multimode interferometer (designated here as the second subunit 205). Alternatively, the phase shifter 125 can be realized by lengthening or shortening the waveguide path of the second coupling-in waveguide 210. The phase shifter 125, as well as the shorter or longer path, can also be realized in both paths of the Mach-Zehnder interferometer as coupling-in unit 104.

The generated signal light can then be sent to a sensor system. For example, this system consists of the Mach-Zehnder interferometer 300, wherein the phase difference between the two paths 315 can be measured. This phase difference can be generated, for example, by the Sagnac effect for an applied rate of rotation.

The sensor signal 340 can then be measured using various measurement methods, for example homodyne detection. Here, the signal laser is combined with the output signal in a beam splitter and the resulting interference is measured by one or two detectors 122 and 335. The latter case is referred to as a balanced homodyne detection, which offers the advantage of low measurement noise. Here, the phase of the signal laser can be varied using phase shifters 125 to optimize the detection. The detectors 122 and 335 can be manufactured directly in integrated fashion or the signal is coupled out via grating couplers 355 or lateral couplers and measured outside the chip. The entire structure is shown by way of example in FIG. 3. A laser or light source 350 is shown, the light of which is coupled into a chip via grating couplers. Alternatively, the laser can also be realized in chip-integrated fashion or coupled in laterally. This is divided in intensity and then first enters the ring to generate the four-wave mixture. The output of the ring having the signal light then enters the Mach-Zehnder interferometer 300. The output, which can be used as a signal laser, is guided past the Mach-Zehnder and interferes again with the signal light at multimode interferometers before the light is coupled out and used for the homodyne detection. It is also shown that part of the signal laser is coupled, for example, into the Mach-Zehnder interferometer 300, with the aim of further amplifying the sensor signal. It is to be noted that any of these uses or any of the signal laser paths can also be omitted. Thus, it is also possible to use any number of phase shifters 125 in the lowest waveguide path and/or the sensor region.

In a further exemplary embodiment, a phase shifter 125 is located above the ring resonator 115. This allows a closed control loop to be formed, in that the phase shifter counteracts the Sagnac effect and adjusts the phase accordingly. This allows the sensor to be kept in the most sensitive region. The phase shifters can be realized via thermal or electro-optical effects.

In a further exemplary embodiment, a temperature sensor is also located on the system, so that the control loop is supplemented with this information and the system thus becomes even more robust against temperature changes.

In a further embodiment, a material having a high second-order susceptibility is located above the ring resonator 115, or the waveguide consists directly of this material, for example periodically poled lithium niobate (PPLN). This allows the three-wave mixture to be realized. This has the advantage that a higher intensity of the quantum states can be achieved. Alternatively, certain waveguide portions can be made of, for example, PPLN, while other sections are made of a different material or a different doping.

Any combination of the components of the embodiments presented here is also conceivable.

In addition to the intensity of the pump light, the wavelength of the quantum states created by four-wave mixing also depends on the resonance condition and length of the resonator or ring resonator 115. If a rotation acts on the system or the sensor unit 100 with the rotation rate, the Sagnac effect takes effect and an effective change occurs in the length of the system compared to the length at rest L₀. This can be described as follows:

$${L}_{e f f}^{\pm } = {L}_{0} \pm \frac{{L}_{0}}{2 π} Ω t$$

Here, t describes the circulation time for an applied rotation rate, which is given by the group velocity v_{g} through

$$t = \frac{{L}_{0}}{{v}_{g}} .$$

The path length difference results as

$$Δ L = {L}_{e f f}^{+} - {L}_{e f f}^{-} = \frac{{L}_{0}^{2}}{π {v}_{g}} Ω$$

Thus, the quantum state generated by the left-hand pump laser and the one generated by the right-hand pump laser are generated with a different effective length.

The four-wave mixing process depends on the phase condition and thus on the resonance condition in the ring and also on the resonance condition of the pump light. If the effective length is shifted, the resonance condition in the ring changes along with it:

$${λ}_{r e s} = \frac{{n}_{e f f} L}{m}$$

With an integer number m, the effective refractive index n_{eff} and the ring length L. If the effective length is changed, the pump wavelength moves out of resonance and as a result the parameter σ in FIG. 1 and thus the generated quantum state effectively change. This causes the squeezing as well as the intensity to vary. This change can be used as a signal to measure the rotation rate.

If the ring resonator 115 is now pumped asymmetrically and an applied rate of rotation causes a change in length, this gives rise to a quantum state with high squeezing and low intensity and another quantum state with low squeezing and high intensity, both of which differ in their frequency. Both quantum states can be mixed at beam splitters, as shown in FIG. 4, and then homodyne measurement can take place. The intensity, as well as the squeezing, provides information about an applied rate of rotation.

Since an applied rate of rotation varies the effective length, this also has effects on the generated wavelength with

$${ω}_{S} = {ω}_{0} - \sqrt{\frac{( X + 1 - {e}^{- \frac{α {L}_{0}}{4.23}} )}{{β}_{2} {L}_{0}}} + \frac{1}{2} \frac{( X + 1 - {e}^{- \frac{α {L}_{0}}{4.23}} ) c}{{n}_{e f f} {L}_{0}} ,$$

where X represents the coupling between ring and waveguide, α represents the optical losses, ω₀ represents the pump frequency and c represents the speed of light. Since the lengths of the left-hand and right-hand waves change differently, different frequencies arise in the quantum states and in the mixing at the beam splitter a beat note arises in the signal. Since the wavelength differences are usually small, the beat note is in the kHz to MHz range of the measured spectrum. The frequency of this beat note signal depends on the applied rate of rotation. This results in two possible measurement methods for expanding the previous measurement:

In this context, intensity-modulated means that the spectrum is measured in its intensity at a specific defined frequency. Since the beat note has a wider width, at a given measured frequency the intensity changes when the frequency changes.

Frequency-modulated, on the other hand, means that the frequency of the beat note is determined in the spectrum. The rate of rotation can be determined from the measured frequency or the beat note.

The measurement setup in FIG. 4 can be used for both. This can also be performed with the structures from FIGS. 1, 2 and 3. It is not absolutely necessary that the ring resonator 115 has to be pumped asymmetrically. It can also be pumped symmetrically with power levels above or below the critical level. This means that the lights arising in the ring can be pumped well above or below the critical point or can be pumped differently. The measurement can thus be performed with the resulting squeezed or coherent light. What is important is only that the ring resonator 115 is or can be pumped from two different directions. Any ring geometry can be used here. In this way, a so-called “horse racing track” ring or any other shape can be realized in which the resonance conditions apply.

In a further exemplary embodiment, a combined measurement is performed between the classic ring laser angular rate sensors and the frequency measurement. In classical ring laser gyroscopes, the transmitted power changes for an applied rotation rate. Thus, the measurement system from FIG. 4 can be extended to also measure the transmitted power of the pump power and to combine this with the previously mentioned frequency-modulated or intensity-modulated measurement in order to increase the information content. This is possible with the existing detectors. Alternatively, additional detectors can be implemented which are optimized for intensity measurement and specifically detect the pump power and, if applicable, use this detection to control the resonance condition in the ring resonator via phase shifters.

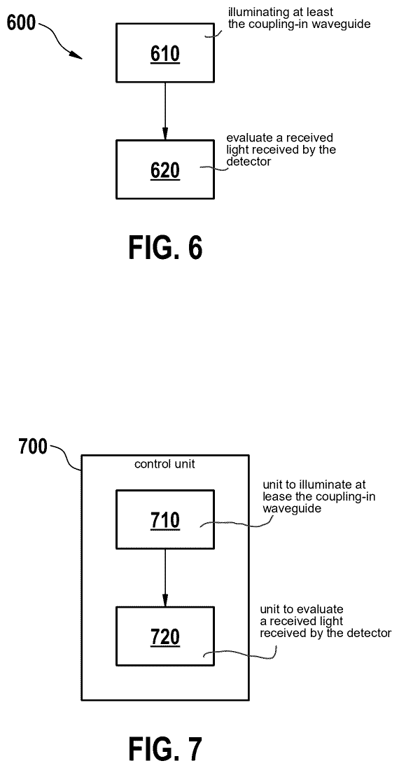

FIG. 6 shows a flow diagram of an exemplary embodiment of a method 600 for operating a variant of a sensor unit presented here, wherein the method 600 comprises a step 610 of illuminating at least the coupling-in waveguide having a light and a step 620 of evaluating a received light received by at least the detector in order to obtain the sensor signal.

FIG. 7 shows a block diagram of an exemplary embodiment of a control unit 700 for executing steps 610 and 620 of the method 600 for operating the variant of the sensor unit presented here. The control unit 700 comprises a unit 710 for illuminating at least the coupling-in waveguide having a light and a unit 720 for evaluating a received light received by at least the detector in order to obtain a sensor signal.

If an exemplary embodiment has an “and/or” link between a first feature and a second feature, this is to be understood to mean that the exemplary embodiment according to one example has both the first feature and the second feature and, according to a further exemplary example, either only the first feature or only the second feature.

What is claimed is:

1. A sensor unit, comprising:
a coupling-in waveguide;
a coupling-in unit configured to couple a state present on the coupling-in waveguide to a first waveguide and a second waveguide;
a first coupling-out unit configured to couple in a state present on the first waveguide to a coupling waveguide and to couple out a state present on the coupling waveguide to a first coupling-out waveguide;
a second coupling-out unit configured to couple in a state present on the second waveguide to the coupling waveguide and to couple out a state present on the coupling waveguide to a second coupling-out waveguide;
a ring resonator configured to couple with the coupling waveguide; and
a detection unit including at least one detector configured to detect: (i) states present at or output from the first and/or second coupling-out waveguide, or (ii) states dependent on the states present at or output from the first and/or second coupling-out waveguide.

2. The sensor unit according to claim 1, wherein the coupling-in unit is configured to couple the state present on the coupling-in waveguide asymmetrically to the first waveguide and the second waveguide.

3. The sensor unit according to claim 1, wherein the coupling-in unit includes at least a first and a second subunit, wherein the first subunit is configured to to couple the state present at the coupling-in waveguide to at least two coupling-in sub-waveguide, wherein the second subunit is coupled with the at least two coupling-in sub-waveguides

4. The sensor unit according to claim 1, wherein a Mach-Zehnder interferometer is arranged between the first and the second coupling-in waveguide and the at least one detector, wherein an interferometer coupling-in unit is provided which is configured to couple a state from the first and second coupling-out waveguide and to couple the state from the first and second coupling-out unit into the Mach-Zehnder interferometer.

5. The sensor unit according to claim 4, wherein the second coupling-out waveguide is coupled with the at least one detector in a manner bypassing the Mach-Zehnder interferometer.

6. The sensor unit according to claim 1, wherein the detection unit includes at least one further detector for detecting: (i) states present at or output from the first and/or second coupling-out waveguide, or (ii) states dependent on the states present at or output from the first and/or second coupling-out waveguide.

7. The sensor unit according to claim 6, wherein the detection unit is configured to provide a sensor signal using a detection signal of the first detector and a further detection signal of the at least one further detector, wherein the sensor signal represents a rate of rotation and/or rotation of the sensor unit.

8. The sensor unit according to claim 1, further comprising at least one light source and/or a laser light source configured to transmit a light into the coupling-in waveguide.

9. The sensor unit according to claim 1, wherein the ring resonator is configured to generate a quantum state using four-wave mixing and/or three-wave mixing and/or a Kerr effect, the ring resonator including Si and/or SiN and/or PPLN and/or GaAs.

10. The sensor unit according to claim 1, further comprising at least one grating coupler configured to couple light into the coupling-in waveguide or to output light to at least the detector of the detection unit.

11. The sensor unit according to claim 1, wherein:
the sensor unit further comprises at least one phase shifter element for varying a state guided on: (i) the first and/or second waveguide, and/or (ii) the coupling-in sub-waveguide and/or (iii) the Mach-Zehnder interferometer, and/or
the sensor unit has a temperature sensor for ascertaining a temperature for controlling an operation of the sensor unit.

12. A method for operating a sensor unit, the sensor unit including:
a coupling-in waveguide,
a coupling-in unit configured to couple a state present on the coupling-in waveguide to a first waveguide and a second waveguide,
a first coupling-out unit configured to couple in a state present on the first waveguide to a coupling waveguide and to couple out a state present on the coupling waveguide to a first coupling-out waveguide,
a second coupling-out unit configured to couple in a state present on the second waveguide to the coupling waveguide and to couple out a state present on the coupling waveguide to a second coupling-out waveguide,
a ring resonator configured to couple with the coupling waveguide, and
a detection unit including at least one detector configured to detect: (i) states present at or output from the first and/or second coupling-out waveguide, or (ii) states dependent on the states present at or output from the first and/or second coupling-out waveguide;
wherein the method comprises the following steps:
illuminating at least the coupling-in waveguide using a light; and
evaluating a received light received by at least the detector to obtain a sensor signal.

13. A control device configured to operate a sensor unit, the sensor unit including:
a coupling-in waveguide,
a coupling-in unit configured to couple a state present on the coupling-in waveguide to a first waveguide and a second waveguide,
a first coupling-out unit configured to couple in a state present on the first waveguide to a coupling waveguide and to couple out a state present on the coupling waveguide to a first coupling-out waveguide,
a second coupling-out unit configured to couple in a state present on the second waveguide to the coupling waveguide and to couple out a state present on the coupling waveguide to a second coupling-out waveguide,
a ring resonator configured to couple with the coupling waveguide, and
a detection unit including at least one detector configured to detect: (i) states present at or output from the first and/or second coupling-out waveguide, or (ii) states dependent on the states present at or output from the first and/or second coupling-out waveguide;
wherein the control unit is configured to:
illuminate at least the coupling-in waveguide using a light; and
evaluate a received light received by at least the detector to obtain a sensor signal).

14. A non-transitory machine-readable storage medium on which is stored a computer program for operating a sensor unit, the sensor unit including:
a coupling-in waveguide,
a coupling-in unit configured to couple a state present on the coupling-in waveguide to a first waveguide and a second waveguide,
a first coupling-out unit configured to couple in a state present on the first waveguide to a coupling waveguide and to couple out a state present on the coupling waveguide to a first coupling-out waveguide,
a second coupling-out unit configured to couple in a state present on the second waveguide to the coupling waveguide and to couple out a state present on the coupling waveguide to a second coupling-out waveguide,
a ring resonator configured to couple with the coupling waveguide, and
a detection unit including at least one detector configured to detect: (i) states present at or output from the first and/or second coupling-out waveguide, or (ii) states dependent on the states present at or output from the first and/or second coupling-out waveguide;
the computer program, when executed by a computer, causing the computer to perform the following steps:
illuminating at least the coupling-in waveguide using a light; and
evaluating a received light received by at least the detector to obtain a sensor signal.
